(19) United States
(12) Patent Application Publication
(10) Pub. No.: US 2017/0205597 A1
(43) Pub. Date: Jul. 20, 2017

(54) METHOD AND SYSTEM FOR PERFORMING ELECTROMAGNETIC INTERFERENCE (EMI) SHIELDING IN AN OPTICAL COMMUNICATIONS MODULE

(71) Applicant: Avago Technologies General IP (Singapore) Pte. Ltd, Singapore (SG)

(72) Inventors: David J.K. Meadowcroft, San Jose, CA (US); Chaitanya Arekar, Dublin, CA (US)

(21) Appl. No.: 15/000,354

(22) Filed: Jan. 19, 2016

(51) Int. Cl. G02B 6/42

(52) U.S. Cl. CPC G02B 6/4277; G02B 6/4292; G02B 6/421; G02B 6/428

(57) ABSTRACT

An optical communications module is equipped with a multi-piece, or split, OSA comprising an OSA receptacle that is separate from the OSA body and that remains spaced apart from the OSA body by wall of the metal module housing once the OSA has been installed in the metal module housing. The wall of the metal module housing has a hole formed in it that has a diameter that is generally equal to the size of the outer diameter of an optical stub of the OSA. The stub extends through the hole and has a proximal end that is secured to the OSA receptacle and a distal end that is secured to the OSA body. The corresponding EMI footprint is limited to being less than or equal to the diameter of the hole.

### TECHNICAL FIELD OF THE INVENTION

The invention relates to optical communications modules. More particularly, the invention relates to methods and devices for use in optical communications modules for providing electromagnetic interference (EMI) shielding.

### BACKGROUND OF THE INVENTION

A variety of optical communications modules exist for transmitting and/or receiving optical data signals over optical data channels or networks. The transmit (Tx) portion of a typical optical transmitter or transceiver module includes a transmitter optical subassembly (TOSA) that includes a laser driver circuit and at least one laser diode. The laser driver circuit outputs an electrical drive signal to the laser diode to cause it to be modulated. When the laser diode is modulated, it outputs optical signals that have power levels corresponding to logic 1s and logic 0s. An optics system of the TOSA directs the optical signal produced by the laser diode into the end of an optical fiber that is mechanically and optically coupled to a receptacle of the TOSA.

The receive (Rx) portion of a typical optical receiver or transceiver module includes a receiver OSA (ROSA) that includes at least one receive photodiode that receives an incoming optical signal output from the end of an optical fiber that is mechanically and optically coupled to a receptacle of the ROSA. An optics system of the ROSA directs the light that is output from the end of the optical fiber onto the receive photodiode. The receive photodiode converts the incoming optical signal into an electrical analog signal. An electrical detection circuit, such as a transimpedance amplifier (TIA), receives the electrical signal produced by the receive photodiode and outputs a corresponding amplified electrical signal, which is processed by other circuitry of the module to recover the data.

In most optical communications modules, the receptacle to which the end of the optical fiber is coupled constitutes an EMI open aperture that allows EMI to escape from the housing of the optical communications module. Standards have been set by the Federal Communications Commission (FCC) that limit the amount of electromagnetic radiation that may emanate from unintended sources. For this reason, a variety of techniques and designs are used to shield EMI open apertures in module housings in order to limit the amount of EMI that passes through the apertures.

Traditional EMI shielding solutions involve electrically grounding the receptacle of the optical subassembly (OSA), which is typically made of metal, to the module housing, which is also typically made of metal. For example, EMI collars are often used with small form factor pluggable (SFP, SFP+) optical communications modules for such purposes. The EMI collars in use today vary in construction, but generally include a band portion that is secured about the outer surface of the metal receptacle and spring fingers having proximal ends that attach to the band portion and distal ends that extend away from the band portion. The spring fingers are periodically spaced about the collar. The distal ends of the spring fingers come into contact with the inner surface of the metal module housing at periodically-spaced points on the housing. Such EMI collar designs are based on Faraday cage principles.

FIG. 1 illustrates a side cross-sectional view of a portion of a known SFP optical communications module 2 that uses an EMI collar 3 as an EMI shielding solution. In the view shown in FIG. 1, only a portion of an OSA 4 of the module 2 is visible. The visible portion of the OSA 4 includes a metal receptacle 4a, a ceramic fiber stub 4b disposed inside of the metal receptacle 4a, and a front portion of a metal OSA body 4c welded to a back portion of the metal receptacle 4a. When an LC optical connector (not shown) disposed on an end of an optical fiber cable (not shown) is mated with an optical port 5 of the module 2, a ferrule of the LC optical connector is received in the metal receptacle 4a in coaxial alignment with the ceramic fiber stub 4b. The SFP optical communications module 2 has a second OSA (not shown) and optical port (not shown) that are identical to the OSA 4 and optical port 5, respectively, disposed on the opposite side of the module 2 that are not visible in the side cross-sectional view shown in FIG. 1.

A band portion (not shown) of the EMI collar 3 is secured to a flange 4a′ of the metal receptacle 4a. EMI fingers 3a of the EMI collar 3 are disposed within recesses 6 formed in the metal module housing 7 and are compressed in between opposing walls 6a of the recesses 6. Through these contact points, the EMI collar 3 electrically grounds the metal receptacle 4a to the metal module housing 7. With this EMI solution, the EMI aperture, or footprint, associated with the metal receptacle 4a, is approximately equal to the outer diameter of the ceramic fiber stub 4b. One disadvantage of this type of EMI shielding solution is that the metal receptacle 4a contributes significantly to the overall cost of the module.

Another traditional EMI shielding solution for use with SFP and SFP+modules involves using an electrically-conductive epoxy to secure the metal receptacle of the OSA to the inner surface of the metal module housing. FIG. 2 illustrates a side cross-sectional view of a portion of the optical communications module 2 shown in FIG. 1, except that the EMI collar 3 has been eliminated and replaced by electrically-conductive epoxy 11. The epoxy 11 is in contact with the flange 4a′ of the metal receptacle 4a and with the walls 6a of the recesses 6. Through these contact points, the epoxy 11 electrically grounds the metal receptacle 4a to the metal module housing 7. With this EMI solution, the EMI footprint associated with the metal receptacle 4a is approximately equal to the outer diameter of the ceramic fiber stub 4b. A disadvantage of this type of EMI shielding solution is that the module printed circuit board (PCB) cannot be reworked once the OSA body 4c has been welded onto the OSA receptacle 4a. The inability to rework module PCB increases costs.

In order to increase bandwidth, data centers are increasing module mounting densities and are using modules that communicate at increasingly higher data rates. In such environments, it is becoming difficult to meet EMI performance requirements. This is especially true for SFP and SFP+ optical communications modules. In addition, cost pressures have incentivized module suppliers to replace the metal OSA receptacles with plastic OSA receptacles. Using a plastic OSA receptacle, however, generally increases the size of the EMI footprint to the size of the outer diameter of the receptacle, which is significantly larger than the size of the outer diameter of the ceramic fiber stub 4b shown in FIGS. 1 and 2.

A need exists for an EMI shielding solution that allows the size of the EMI footprint associated with the OSA receptacle to be decreased. A need also exists for an EMI shielding solution that allows a plastic OSA receptacle to be used while also keeping the EMI footprint relatively small. A need also exists for an EMI shielding solution that does not prevent the reworkability of the optical communication module in which it is employed.

### BRIEF DESCRIPTION OF THE DRAWINGS

FIG. 1 illustrates a side cross-sectional view of a portion of a known SFP optical communications module that uses an EMI collar as an EMI shielding solution.

FIG. 2 illustrates a side cross-sectional view of a portion of the optical communications module shown in FIG. 1, except that the EMI collar has been eliminated and replaced by electrically-conductive epoxy.

FIG. 3 illustrates a top perspective view of the split OSA in accordance with an illustrative embodiment.

FIG. 4 illustrates a top perspective view of a portion of an optical communications module having a module printed circuit board PCB on which the OSA body of the split OSA shown in FIG. 3 is mounted.

FIG. 5 illustrates a side cross-sectional view of the portion of an optical communications module shown in FIG. 4 taken along line A-A′ of FIG. 4.

### DETAILED DESCRIPTION OF AN ILLUSTRATIVE EMBODIMENT

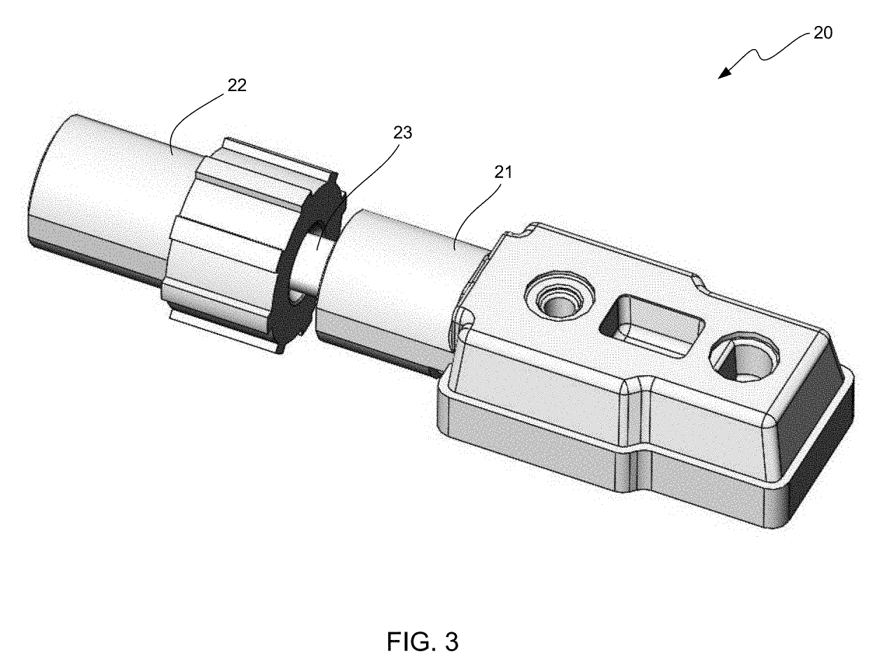

In accordance with an illustrative, or exemplary, embodiment, an optical communications module is equipped with a multi-piece, or split, OSA comprising an OSA receptacle that is separate from the OSA body and that remains spaced apart from the OSA body by wall of the metal module housing once the OSA has been installed in the metal module housing. The wall of the metal module housing has a hole formed in it that has a diameter that is approximately equal to the outer diameter of an optical stub of the OSA. The stub extends through the hole and has a proximal end that is secured to the OSA receptacle and a distal end that is secured to the OSA body. The corresponding EMI footprint is limited to being less than or equal to the diameter of the hole. The illustrative embodiments will be described below with reference to FIGS. 3-5, in which like reference numerals represent like elements, components or features. It should be noted that elements, components or features in the figures are not necessarily drawn to scale, emphasis instead being placed on demonstrating principles and concepts of the illustrative embodiments.

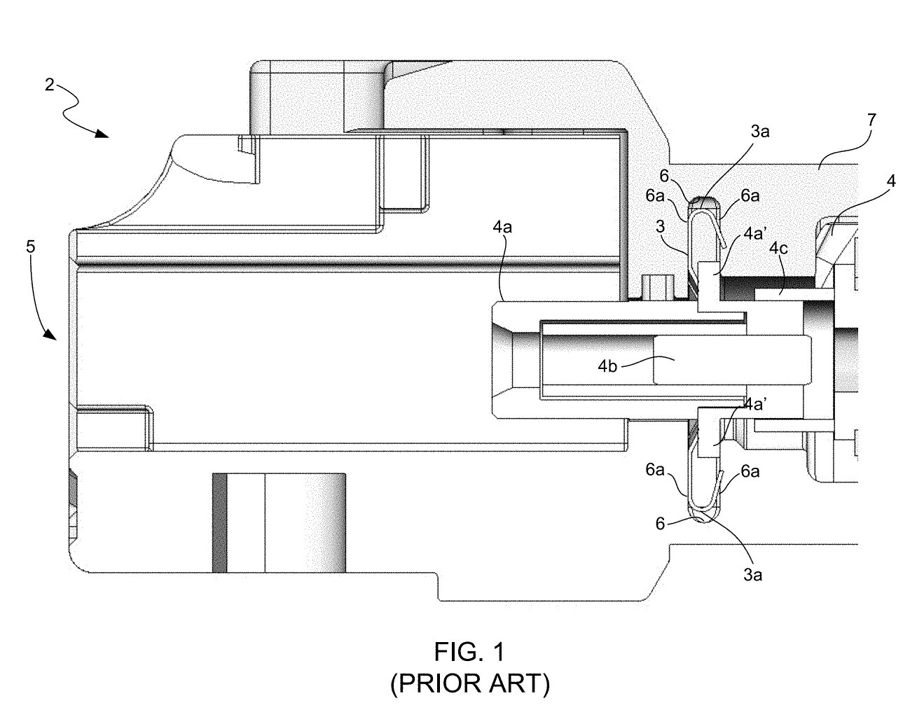

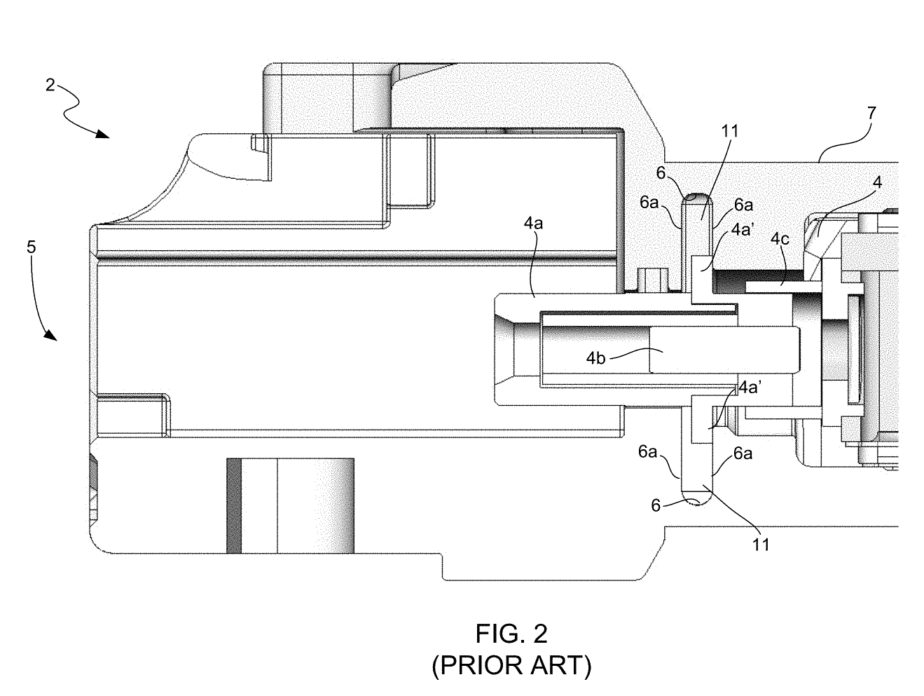

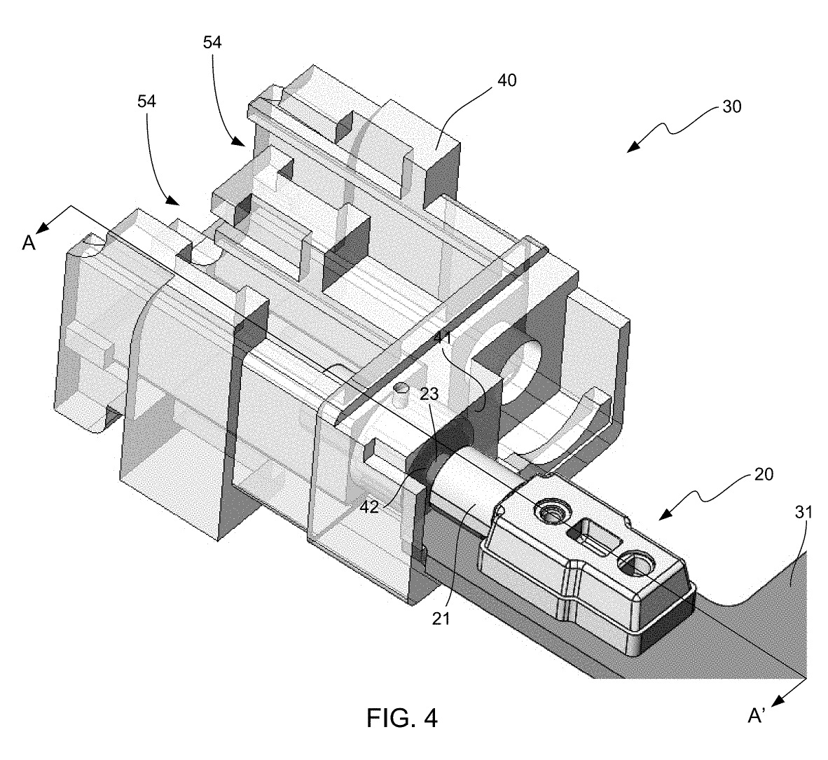

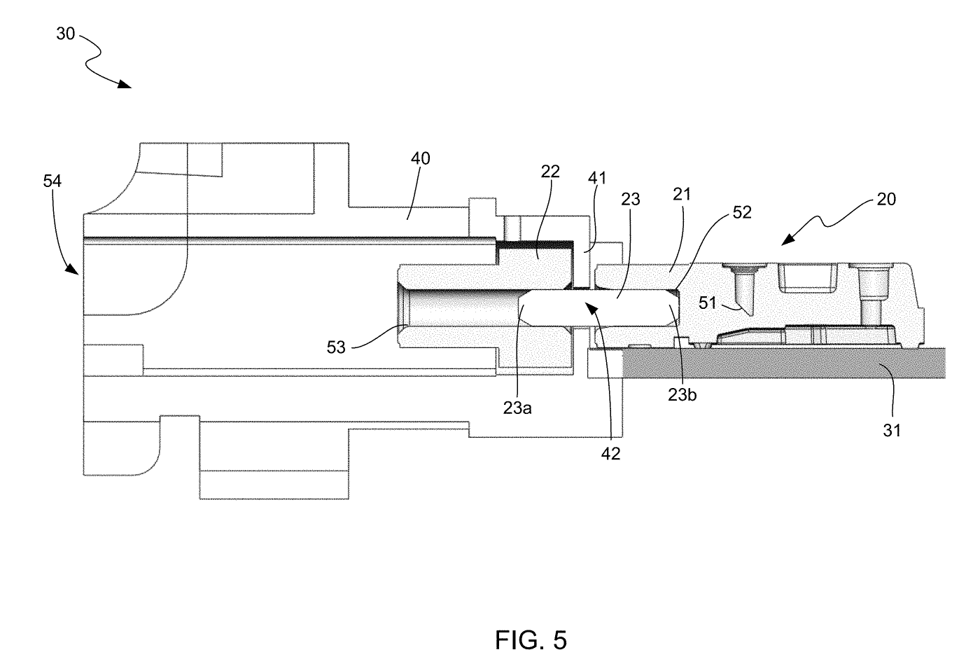

FIG. 3 illustrates a top perspective view of the split OSA 20 in accordance with an illustrative embodiment. FIG. 4 illustrates a top perspective view of a portion of an optical communications module 30 having a module printed circuit board (PCB) 31 on which the OSA body 21 of the split OSA 20 shown in FIG. 3 is mounted. FIG. 5 illustrates a side cross-sectional view of the portion of an optical communications module 30 shown in FIG. 4 taken along line A-A′ of FIG. 4. The split OSA 20 comprises the OSA body 21, an OSA receptacle 22, and an optical stub 23. The OSA 20 is “split” in that the OSA body 21 and the OSA receptacle 22 remain separated from one another, or split apart, after the OSA 20 has been assembled and installed inside of the module 30. This is not the case with the known design shown in FIGS. 1 and 2, in which the front portion of the metal OSA body 4c is welded to the back portion of the metal receptacle 4a.

The OSA receptacle 22 may be similar or identical in size and shape to the OSA receptacle 4a shown in FIGS. 1 and 2. In accordance with this illustrative embodiment, unlike the OSA receptacle 4a shown in FIGS. 1 and 2, the OSA receptacle 22 is made of a non-electrically-conductive material such as plastic, for example. In other embodiments, the OSA receptacle 22 may be made of an electrically-conductive material such as metal, but it is not required to be made of metal. One of the advantages of this EMI containment solution is that the material of which the OSA receptacle 22 is made has no effect on the EMI footprint of the optical communications module 30. The optical communications module 30 has a metal module housing 40 that is similar to the metal module housing 7 shown in FIGS. 1 and 2 except that the metal module housing 40 has a wall 41 that separates the OSA receptacle 20 from the OSA body 21. The wall 41 of the housing 40 has a hole 42 formed in it that has a diameter that is approximately equal to the outer diameter of the stub 23 such that the outer surface of the stub 23 is in contact with, or in very close proximity to, the edges of the hole 42. The stub 23 extends through the hole 42 and has a proximal end 23a that is secured to the OSA receptacle 22 and a distal end 23b that is secured to the OSA body 21.

The hole 42 is the only opening in the module housing 40 through which EMI radiation can pass. The module housing 40 completely surrounds the OSA body 21. The rear portion of the module housing 40 is not shown in FIGS. 3-5 to allow the relationship between the OSA body 21, the OSA receptacle 22, the stub 23 and the wall 41 to be seen. Thus, the module housing 40 is the EMI shielding solution, with only the hole 42 constituting an EMI open aperture through which EMI radiation can potentially pass from the OSA body 21 into the optical port 54 and from the optical port 54 into the surrounding environment. Therefore, there is no need to make the OSA receptacle 22 out of metal, nor is there a need to electrically ground the OSA receptacle 22 to the module housing 40.

The material of which the OSA receptacle 22 is made has no bearing on the EMI footprint of the module 30. Consequently, the metal OSA receptacle 4a shown in FIGS. 1 and 2 can be replaced with a plastic OSA receptacle 22, which reduces costs. The OSA receptacle 22 may be made out of any suitable material, including, for example, plastic, metal and ceramics. In addition, the need to use the EMI collar 3 or the electrically-conductive epoxy 11 shown in FIGS. 1 and 2, respectively, is eliminated. Eliminating the need for a separate EMI shielding device such as the EMI collar 3 also helps reduce the cost of the module 30.

In accordance with this illustrative embodiment, the module 30 is an SFP or enhanced SFP (SFP+) module adapted to mate with a pair of LC optical connectors. Therefore, in accordance with this embodiment, the optical communications module 30 has two of the split OSAs 20 installed therein. Each of the OSA bodies 21 houses optical, electrical and optoelectronic components, such as, for example, one or more lenses, one or more laser diode driver circuits or receiver circuits, and one or more laser diodes or photodiodes. The components that are housed in the OSA bodies 21 depend on whether the module 30 is a transceiver module having a receive channel and a transmit channel, a receiver module having two receive channels, or a transmitter module having two transmit channels. Each OSA body 21 typically also includes an OSA PCB on which the electrical and optoelectronic components are mounted. The module PCB 31 is electrically interconnected with the OSA PCB.

The term “SFP,” as that term is used herein, is intended to denote all types or categories of pluggable optical communications modules, including, but not limited to, SFP+and compact SFP (CSFP) optical communications modules. For example, various categories of SFP optical communications modules include SX, LX, EX, ZX, EZX, BX, XD, ZX, EX, EZX SFP optical communications modules.

The stub 23 is typically a ceramic fiber stub similar or identical to the ceramic fiber stub 4b shown in FIGS. 1 and 2, but may be made of other materials. In the case where the stub 23 is made of a ceramic material, an outer layer of the ceramic material may be removed and replaced with a metal layer to further reduce the size of the EMI footprint of the module 30. As another alternative, the stub 23 may be made of a metallic material having a hollow bore formed in it that extends from the proximal end 23a to the distal end 23b. In the latter case, the bore is suitably sized to couple light in between the end of the optical fiber that is held in the LC optical connector and the OSA body 21. The OSA body 21 has one or more optical components 51 (FIG. 5) disposed therein that couple light between the distal end 23b of the stub 23 and a respective optoelectronic element (e.g., a laser diode or photodiode) disposed in the OSA body 21. Making the stub 23 of a metallic material further reduces the size of the EMI footprint to a diameter that is even smaller than the diameter of the hole 42 formed in the housing wall 41.

An illustrative embodiment of the process of installing the OSA 20 in the module 30 will now be described with reference to FIG. 5. Prior to mounting the OSA body 21 on the module PCB 31, the distal end 23b of stub 23 is press fit into a hollow bore 52 formed in the front of the OSA body 21 that is filled with epoxy. When the epoxy hardens, it forms a bond that fixedly secures the stub 23 to the OSA body 21. The OSA body 21 is then aligned with the module PCB 31, mounted in the aligned position on the module PCB 31 and secured to the module PCB 31 by epoxy. The module PCB 31 having the OSA body 21 thereon is then positioned relative to the module housing 40 to cause the proximal end 23a of the stub 23 to pass through the hole 42 formed in the housing wall 41. The proximal end 23a of the stub 23 is then press fit into a hollow bore 53 formed in the OSA receptacle 22 that is filled with epoxy.

After the epoxy has hardened to fixedly secure the stub 23 to the OSA receptacle 22, the OSA receptacle 22 is aligned with the optical port 54 of the module 30. Once the OSA receptacle 22 has been placed in its aligned position relative to the optical port 54, the OSA receptacle 22 is fixedly secured to the optical port 54 in the aligned position. This same process is performed for each of the optical ports 54 of the module 30.

Another advantage of the EMI shielding solution described above with reference to the illustrative embodiment shown in FIGS. 3-5 is that it allows for the reworkability of the module PCB 31. Unlike the OSA 4 shown in FIGS. 1 and 2 in which the OSA body 4c is welded onto the OSA receptacle 4a, the OSA body 21 and the OSA receptacle 22 remain separate parts after assembly and installation. This allows for the possibility of removing the OSA body 21 and the module PCB 31 on which it is mounted from the module housing 40 and reworking the module PCB 31 so that it can be reused. This feature also reduces costs.

It can be seen from the above that the split OSA 20 provides several advantages, including, for example, improvements in EMI containment resulting from the smaller EMI footprint, reductions in costs resulting from using a plastic OSA receptacle, reductions in costs due to eliminating the need for an EMI collar or similar devices, and reductions in costs due to the ability to rework the module PCB.

It should be noted that the invention has been described with respect to illustrative embodiments for the purpose of describing the principles and concepts of the invention. The invention is not limited to these embodiments. As will be understood by those skilled in the art in view of the description being provided herein, modifications may be made to the embodiments described herein without deviating from the scope of the invention. For example, while the EMI shielding solution has been described with reference to a particular optical communications module configuration, the invention is not limited to being used with optical communication modules having any particular configuration.

What is claimed is:

1. A split optical subassembly (OSA) for use in an optical communications module for mechanically coupling an end of an optical fiber cable with the module and for optically coupling light between the end of the optical fiber cable and at least one optoelectronic device mounted on a circuit board of the module, the split OSA comprising:
an OSA receptacle having a first end and a second end, wherein a hollow bore extends between the first and second ends, the first end of the OSA receptacle being adapted to mate with an optical connector such that a ferrule of the optical connector is received in the bore at the first end of the OSA receptacle, the bore being adapted to receive a proximal end of an optical stub at the second end of the OSA receptacle; and
an OSA body having a first end, a second end, a top, and a bottom, wherein a hollow bore is formed in the first end of the OSA body and extends a distance into the OSA body from the first end, and wherein the hollow bore formed in the first end of the OSA body is adapted to receive the distal end of the optical stub, and wherein when the proximal and distal ends of the optical stub are disposed in the hollow bores formed in the OSA receptacle and the OSA body, respectively, the second end of the OSA receptacle is spaced apart from the first end of the OSA body such that a gap exists between the second end of the OSA receptacle and the first end of the OSA body.

2. The split OSA of claim 1, wherein the split OSA is adapted for use in a small form factor pluggable (SFP) optical communications module.

3. The split OSA of claim 2, wherein the optical connector with which the first end of the OSA receptacle is adapted to mate is an LC optical connector.

4. An optical communications module comprising:
a module housing made of an electrically-conductive material, the module housing having at least a first optical port for receiving an end of an optical fiber cable, the module housing having a wall disposed at a back end of the first optical port, the wall having a hole formed therein; and
a split optical subassembly (OSA) comprising an OSA receptacle, an OSA body and an optical stub, the OSA receptacle being disposed in the first optical port, the OSA receptacle having a first end and a second end, wherein a hollow bore extends between the first and second ends of the OSA receptacle, the OSA body having a first end and a second end, wherein a hollow bore is formed in the first end of the OSA body, the second end of the OSA receptacle being proximate a first side of the wall, the first end of the OSA body being proximate a second side of the wall, the optical stub passing through the hole formed in the wall, wherein a proximal end of the optical stub is disposed inside of the hollow bore of the OSA receptacle at the second end of the OSA receptacle, and wherein a distal end of the optical stub is disposed in the hollow bore of the OSA body, the wall separating the second end of the OSA receptacle from the first end of the OSA body.

5. The optical communications module of claim 4, wherein the wall is perpendicular to an optical axis of the optical stub and the hole has a diameter that is approximately equal to an outer diameter of the optical stub.

6. The optical communications module of claim 5, wherein the OSA receptacle is made of a non-electrically-conductive material.

7. The optical communications module of claim 5, wherein the OSA receptacle is made of a metallic material.

8. The optical communications module of claim 5, wherein the OSA receptacle is made of a plastic material.

9. The optical communications module of claim 8, wherein the optical stub is a ceramic fiber stub.

10. The optical communications module of claim 9, wherein an outer layer of the ceramic fiber stub comprises metal, and wherein the outer layer of metal is in contact with edges of the hole.

11. The optical communications module of claim 8, wherein the optical stub is made of a metallic material having a hollow bore formed therein, and wherein an outer surface of the optical stub is in contact with edges of the hole.

12. The optical communications module of claim 5, further comprising:
a module circuit board, wherein the OSA body is mounted on a mounting surface of the module circuit board, the mounting surface being parallel to an optical axis of the optical stub.

13. The optical communications module of claim 12, wherein the OSA body has at least a first optoelectronic device disposed therein and at least a first optical device disposed therein, wherein the first optical device directs light at a ninety degree angle relative to the optical axis of the optical stub between the distal end of the optical stub and the first optoelectronic device.

14. The optical communications module of claim 13, wherein the optical communications module is a small form factor pluggable (SFP) optical communications module.

15. The optical communications module of claim 14, wherein the first end of the OSA receptacle is adapted to mate with an LC optical connector when the LC optical connector is connected to the first optical port, wherein when the first end of the OSA receptacle is mated with the LC optical connector, a ferrule of the LC optical connector is received in the hollow bore of the OSA receptacle at the first end of the OSA receptacle.

16. A small form factor pluggable (SFP) optical communications module comprising:
a module housing made of an electrically-conductive material, the module housing having at least a first optical port for receiving an end of an optical fiber cable, the module housing having a wall disposed at a back end of the first optical port, the wall having a hole formed therein; and
a split optical subassembly (OSA) comprising an OSA receptacle, an OSA body and an optical stub, the OSA receptacle being disposed in the first optical port such that a first end of the OSA receptacle faces away from the wall and a second end of the OSA receptacle faces the wall, wherein a bore extends between the first and second ends of the OSA receptacle, the OSA body being disposed on an opposite side of the wall from the OSA receptacle and having a first end that faces the wall and a second end that faces away from the wall, wherein a hollow bore is formed in the first end of the OSA body, a proximal end of the optical stub being disposed inside of the hollow bore of the OSA receptacle at the second end of the OSA receptacle, the distal end of the optical stub being disposed inside of the hollow bore of the OSA body, wherein the wall separates the OSA receptacle and the OSA body from one another and limits an electromagnetic interference (EMI) footprint of the OSA to a size that is less than or equal to a diameter of the hole.

17. The optical communications module of claim 16, wherein the OSA receptacle is made of a non-electrically-conductive material.

18. The optical communications module of claim 16, wherein the OSA receptacle is made of a metallic material.

19. The optical communications module of claim 16, wherein the OSA receptacle is made of a plastic material.

20. The optical communications module of claim 16, wherein the optical stub is ceramic fiber stub.

21. The optical communications module of claim 20, wherein an outer layer of the ceramic fiber stub comprises metal, and wherein the outer layer of metal is in contact with edges of the hole, and wherein the contact between the outer metallic layer of the stub and the edges of the hole limits the EMI footprint of the OSA to a size that is less than or equal to a diameter of a ceramic portion of the stub.

22. The optical communications module of claim 16, wherein the optical stub is made of a metallic material having a hollow bore formed therein, and wherein an outer surface of the optical stub is in contact with edges of the hole, and wherein the contact between the outer metallic layer of the stub and the edges of the hole limits the EMI footprint of the OSA to a size that is less than or equal to a diameter of the bore formed in the metallic material of the stub.
